(19) United States
(12) Patent Application Publication
(10) Pub. No.: US 2004/0166325 A1
(43) Pub. Date: Aug. 26, 2004

(54) Flame retardant molding compositions containing group IVA metal oxides

(75) Inventors: Anthony A. Gallo, Olean, NY (US); Tom Raught, Rixford, PA (US)

Correspondence Address: Webb Ziesenheim Lodsdon, Orkin & Hanson, P.C., 700 Koppers Building, 436 Seventh Avenue, Pittsburgh, PA, 15219-1818, US

(73) Assignee: Henkel Loctite Corporation

(21) Appl. No.: 10/644,791

(22) Filed: Aug. 19, 2003

Related U.S. Application Data
(63) Continuation-in-part of application No. 10/369,916, filed on Feb. 20, 2003.

(51) Int. Cl. B32B 27/38

(52) U.S. Cl. 428/413

(57) ABSTRACT

A molding composition that is particularly useful for coating and encapsulating electronic or electrical devices is disclosed. The molding composition exhibits improved flame retardancy and includes an epoxy resin, a hardener for the epoxy resin, and flame retardant compounds of melamine cyanurate and an oxyanion of a Group VIA element, such as tungsten trioxide.

### CROSS-REFERENCE TO RELATED APPLICATIONS

This application is a continuation-in-part of application Ser. No. 10/369,916 filed Feb. 20, 2003 and entitled “Molding Compounds Containing Quaternary Organophosphonium Salts”.

### TECHNICAL FIELD OF THE INVENTION

This invention relates to molding compounds for electrical and electronic devices, and particularly epoxy-based molding compounds exhibiting flame resistance.

### BACKGROUND OF THE INVENTION

Epoxy resin is widely used in molding compounds for coating electrical and electronic devices. Such epoxy molding compounds used for encapsulation are generally prepared from a blend of an epoxy resin and a phenolic hardener, along with other ingredients including fillers, catalysts, flame retardant materials, processing aids and colorants.

Molding compositions containing epoxy resins often include flame retardants for safety purposes. A common flame retardant system is a combination of bromine containing flame retardants and antimony oxide flame retardant synergists. However, these compounds are pollutants of the environment. Some bromine containing flame retardants (especially brominated diphenyl ethers) are toxic and possibly carcinogenic. Antimony trioxide is classified by the International Agency for Research on Cancer as a Class 2B carcinogen (i.e., antimony trioxide is a suspect carcinogen based mainly on animal studies). In addition, this compound is often used at relatively high levels (2-4%) and is also slightly water-soluble, leading to further environmental concerns. This concern is highlighted by the fact that integrated circuit manufacturers currently discard up to one-half of the total amount of molding compositions used.

Phosphorous-containing compounds have been proposed as flame retardants. Although they are less hazardous, molding compositions containing these compounds generally possess undesirable properties such as a high moisture absorption, which can cause stress and cracking of the encapsulant at elevated temperatures.

Melamine cyanurate, commonly sold as an effective flame retardant compound, can severely reduce the flowability of molding compounds when present at high levels. As a result, it has been impractical to incorporate melamine cyanurate into molding compounds at appropriate levels for both adequate flame retardancy and flowability. Reducing the amount of the flame retardant to address issues such as flowability compromises flame retardance, thereby causing the molding compound to fail to meet the flame retardance standard, UL-94 V-O rating.

Thus, there exists a need to develop new flame retardant molding compositions which overcome the disadvantages of the prior art such as environmental concerns and high moisture absorption, while providing acceptable physical properties. Moreover, it would be desirable to provide molding compositions with excellent stress characteristics such as low warpage and shrinkage with improved flowability during curing.

### SUMMARY OF THE INVENTION

The invention relates to flame retardant molding compositions that are substantially free of halogen, phosphorous, and antimony. In addition to having good flame retardant properties, these compositions absorb low amounts of moisture, and can be used to coat electronic or electrical devices such as semiconductors, diodes, and integrated circuits. Such coated devices demonstrate good electrical reliability at high temperatures.

One embodiment of the invention provides a flame retardant molding composition including an epoxy resin, melamine cyanurate, and a transition metal oxide containing an oxyanion of a Group VIA element, such as tungsten trioxide.

Another embodiment of the invention provides a method for imparting flame retardancy by combining the epoxy molding composition with melamine cyanurate and a transition metal oxide containing an oxyanion of a Group VIA element, such as tungsten trioxide.

In an additional embodiment, the invention is directed to an encapsulant for an electrical or electronic device, a further embodiment is a method for coating an electrical or electronic device. The method for coating an electric or electrical device includes providing a molding composition as set forth above; contacting a surface of the device with the molding composition; and heating the molding composition to a temperature sufficient to cure the molding composition and form a polymer on the surface of the device.

Other features and advantages of the invention will be apparent from the description of the various embodiments thereof, and from the claims.

### DETAILED DESCRIPTION OF THE INVENTION

The present invention is directed to a composition of matter, and in particular to a molding compound such as for use in encapsulating electronic packages such as semiconductor devices. In general, the molding compound includes an epoxy resin and a curing agent for the epoxy resin, as well as a melamine cyanurate and a transition metal oxide containing an oxyanion of a Group VIA element.

As used herein, a molding composition is cured when it forms a good cull cure (i.e., strong and not brittle).

A typical molding composition as provided by the present invention comprises an epoxy resin, a curing agent for the epoxy resin, a transition metal oxide containing an oxyanion of a Group VIA element and melamine cyanurate. Typically the composition is essentially free of bromine and antimony compounds.

There is no restriction on the type of epoxy resin that can be used in the molding compositions so long as it contains two or more reactive oxirane groups. For example, the epoxy resin can include, but is not limited to, bisphenol A type epoxy resins, novolac type resins such as epoxy cresol novolac resin and phenolic novolac epoxy resin, alicyclic epoxy resins, glycidyl type epoxy resins, biphenyl epoxy resins, naphthalene ring-containing epoxy resins, cyclopentadiene-containing epoxy resins, polyfunctional epoxy resins, hydroquinone epoxy resins, and stilbene epoxy resins. The molding compositions can include more than one epoxy resin, as a non-limiting example, a combination of epoxy cresol novolac resin and biphenyl epoxy resin.

As noted, bisphenol and biphenyl epoxy resins, which are traditionally referenced as di-epoxies, and epoxy cresol novolac resins, which are traditionally referenced as multifunctional epoxies, are useful in the present invention. Such epoxies have a degree of branching of two, in that two phenolic groups having pendant epoxies are linked through the same carbon atom. For example, diglycidyl ether of bisphenol A is difunctional, including two phenolic groups with pendant epoxies extending from a central carbon atom. It therefore has a degree of branching of two. Epoxy cresol novolac resins are oftentimes referenced as “multifunctional”, in that they are polymeric compounds with a plurality of pendant epoxy moieties which may extend from the polymeric chain. For example, epoxy cresol novolac resins include the following structure:

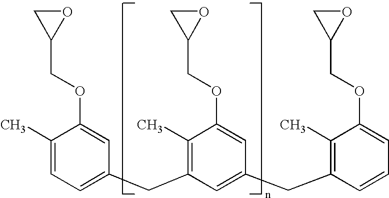

This compound is traditionally referred to as a multifunctional epoxy resin, and the degree of branching of this type of resin is equal to two.

The epoxy resin may also be a multifunctional epoxy resin having a degree of branching within the resin backbone of at least three. Thus, particularly desirable multifunctional epoxy resins are those derived from phenol and which include at least three phenolic groups branching directly from the same central carbon atom or central cluster of carbons, with a pendant oxirane group linked to each of the at least three phenolic groups. Non-limiting examples of useful multifunctional epoxy resins having a degree of branching of at least three include:

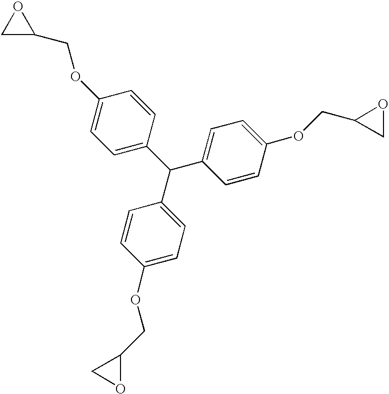

triphenylol methane triglycidyl ether (having a degree of branching of three, represented by three terminal glycidyl ether moieties branching from a central carbon atom); and

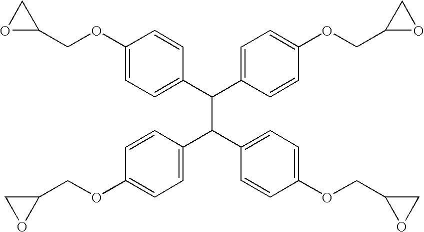

tetra glycidyl ether of tetra phenol ethane (having a degree of branching of four, represented by four terminal glycidyl ether moieties branching from a central two carbon cluster ethyl moiety). Such multifunctional resins having a degree of branching of at least three may be used alone, or in combination with other resins such as those described above.

The epoxy resin typically has a theoretical epoxy equivalent weight of about 150 to about 250. In the present molding composition, the epoxy resin is present at a level of at least about 1 percent by weight of the total composition, and may be present in an amount of up to about 25 percent by weight of the composition. The molding composition may contain the epoxy resin in any range of values inclusive of those stated above. In one embodiment of the invention the epoxy resin is present in the composition of the present invention in an amount of about 4 to about 12 percent by weight, more desirably, about 5.5 to about 8.5 percent by weight, based on the total weight of the composition.

The composition of the present invention further includes a curing agent (hardener), which promotes crosslinking of the molding composition to form a polymer composition upon heating of the composition, such as by heating to a temperature of at least 135° C. Some suitable curing agents that can be included in the molding compositions of the present invention include, but are not limited to, limonene type hardeners, anhydrides, and phenolic novolac type hardeners. A particular embodiment of this invention uses phenolic novolac hardeners. Flexible hardeners having a hydroxyl equivalent weight greater than about 150 are often desirable, such as xylock novolac type hardeners. Non-limiting examples of flexible hardeners include bisphenol M, which is commercially available from Borden Chemical, and DEH 85, which is commercially available from Dow Chemical. Similar to the epoxy resin component, more than one type of curing agent can be included in the molding compositions.

As with the epoxy resin component, multifunctional hardeners having a degree of branching of at least three are also useful in the present invention, such as those derived from tris-phenol and which contain at least three functional groups that are reactive with epoxide groups.

The curing agent (hardener) is typically present in the composition of the present invention in an amount of about 0.001 percent by weight to about 10 percent by weight, and in one embodiment from about 1.5 percent by weight to about 6 percent by weight, based on the total weight of the composition. The molding composition may contain the curing agent (hardener) in any range of values inclusive of those stated above.

The composition further includes a specific combination of materials to impart flame retardancy or flame resistance to the composition, without adversely affecting molding properties such as flowability. In particular, it has been discovered through the present invention that the combination of melamine cyanurate and transition metal oxides containing an oxyanion of a Group VIA element create a synergistic effect with respect to flame retardation when compared to those compositions that do not contain both of these components. For example, in traditional molding compositions, for melamine cyanurate to be an effective flame retardant, it must be included in a significant amount, which adversely impacts the molding compound's properties such as reducing the flowability. It has been unexpectedly discovered, however, that a reduced amount of melamine cyanurate can be included in a molding composition as a flame retardant in combination with specific transition metal oxides containing an oxyanion of a Group VIA element, with the molding composition retaining good flowability and yet possessing flame retardancy better than would be achieved with either the melamine cyanurate or the transition metal oxide alone.

Flame resistance may be measured using any acceptable testing method known to those skilled in the art. A standard test for measuring flammability and/or combustibility is known as Underwriters Laboratories UL 94, “Test for Flammability of Plastic Materials—UL-94” (Jul. 29, 1997), the disclosure of which is hereby expressly incorporated herein by reference. In this test, the materials are classified as V-0, V-1, or V-2, depending on the flame-retardant performance of the material. Particularly desirable materials in accordance with this invention should reach a V-0 classification, although certain formulations may be classified at a lower level (such as V-1), depending on the end use for which the material is intended. Details of this test and the performance of cured reaction products within the scope of the invention under test conditions are provided below in the examples.

In the present molding composition, the melamine cyanurate is present at a level of at least about 0.1 percent by weight, and up to about 3.5 percent by weight based on the total weight of the composition. The molding composition may contain the melamine cyanurate in any range of values inclusive of those stated above.

The transition metal oxide may be any metal oxide containing an oxyanion of a Group VIA element. Examples of useful transition metal oxides include, but are not limited to, chromium oxides, molybdenum oxides, tungsten oxides, and mixtures thereof. Tungsten oxides, and in particular tungsten trioxide, is particularly desirable for use in the present invention. The transition metal oxide is present at a level of at least about 0.1 percent by weight, and up to about 2 percent by weight, based on the total weight of the composition. The molding composition may contain transition metal oxide in any range of values inclusive of those stated above.

The composition may further include a catalyst for promoting reaction of the epoxy resin and the hardener. Traditionally, such epoxy compositions incorporate catalysts such as tertiary amines, substituted phosphines, imidazoles, and the like, with compounds such as 1,8-diazabicyclo[5.4.0]undec-7-ene (“DBU”), dicyandiamide (“DICY”) and triphenylphosphine (“TPP”) being particularly well known for use as catalysts.

The compositions of the present invention can include other optional additives well known to those of skill in the art. For example, fillers such as silica, alumina, aluminosilicate, aluminum trihydrate, silicon nitride, clay, talc, mica, kaolin, calcium carbonate, wollastonite, montmorillonite, smectite, and combinations thereof are commonly present in the composition, in amounts of about 5 to about 90 percent by weight, often from about 50 to about 90 percent by weight, and desirably from about 60 to about 90 percent by weight, based on the total weight of the composition. The molding composition may contain fillers in any range of values inclusive of those stated above.

A colorant such as carbon black colorant may also be included in the composition of the present invention in amounts of about 0 to about 2 percent by weight, more often from about 0.1 to about 1 percent by weight, when present. The molding composition may contain the colorant in any range of values inclusive of those stated above.

The compositions of the present invention may also include further additives, for example coupling agents, such as the silane type coupling agent; mold release agents such as carnauba wax, paraffin wax, polyethylene wax, ester waxes (such as EWAX commercially available from Hoechst Chemical), acid waxes (such as SWAX commercially available from Hoechst Chemical), glycerol monostearate, and metallic stearates; catalysts such as DBU, TPP, DICY and 2-methylmidazole; ion scavengers such as magnesium aluminum carbonate hydrate, which can be obtained commercially from Kyowa Chemical Industry Co. under the trade name “DHT-4A”; pigments; adhesion promoters such as azine adhesion promoters; toughening agents; UV absorbers; and antioxidants. Examples of other additives may include stress relievers such as polyphenyleneoxide and elastomers such as powdered silicone.

In the present molding composition, such additives, when present, may be present in any useful amount so as not to interfere with the molding properties of the composition. For example, such additives can be present at a level of from about 0 percent, up to about 10 percent by weight of the composition. The molding composition may contain additives in any range of values inclusive of those stated above.

The invention also establishes a method of imparting flame retardancy by combining the epoxy molding composition with melamine cyanurate and a transition metal oxide containing an oxyanion of a Group VIA element.

The molding compositions can be prepared by any conventional method. For example, as is known in the art, all of the compounds may be combined and finely ground and dry blended, or the components can be mixed in a step-wise fashion to enhance homogeneous mixing. The mixture can then be treated on a hot differential roll mill such as with a large two-roll mill (one roll heated to about 90° C., and the other cooled with tap water) to produce uniform sheets, which are then ground to a powder after cooling. Alternatively, the mixture can be extruded through a twin screw extruder, as known in the art.

The molding compositions can be molded into various articles by any conventional method, e.g., by using a molding apparatus such as a transfer press equipped with a multi-cavity mold for coating electronic devices. Suitable molding conditions typically involve heating in the cavity to a temperature of about 130° C. to about 200° C., desirably from about 165° C. to about 195° C., and at a pressure of about 400 psi to about 1,500 psi. The temperature and pressure conditions may be in any range of values inclusive of those stated above.

The molding compositions are formulated so as to cure in about 0.5 minutes to about 3 minutes, more desirably within about 1-2 minutes. To determine the time for curing (i.e., minimum time needed for forming a good cull cure), the molding composition is placed in the mold press at 190° C. and is inspected after a pre-set period of time (e.g., 3 minutes). If a good cure (i.e., strong and not brittle) is formed, the experiment is repeated with a shorter period of press time until the minimum time period is determined.

The molding compositions of the present invention typically demonstrate a flammability rating of UL 94 V-1 or of UL 94 V-0. The ratings are determined by measuring the total burn time of a ⅛″ bar according to the UL 94 flammability test. A UL 94 V-0 and a UL 94 V-1 rating require the total burn time for a single bar to be less than or equal to 10 seconds and 30 seconds, respectively.

As noted above, the compositions of the present invention are particularly useful as molding compounds for electrical or electronic devices. Accordingly, a further embodiment of the present invention provides a method for coating an electrical or electronic device such as a semiconductor, a transistor, a diode, or an integrated circuit, as well as an electronic device prepared as such. The method of coating an electronic device involves providing a molding composition as discussed above, and contacting a surface of an electronic device with the molding composition, such as by coating the composition thereon. The device including the molding composition thereon is then heated to a temperature sufficient to cure the molding composition and form a polymer on the surface of the device. Desirably, the temperature to which the molding composition is heated is typically at least to 135° C., and in one embodiment of the invention it is about 165° C. to about 195° C.

### EXAMPLES

### Example 1

A molding composition represented as Sample 1 was prepared according to the formulation as indicated in Table 1A below. The molding composition contained an epoxy cresol novolac resin with a standard phenol novolac hardener, and melamine cyanurate as a flame retardant. The weight % (wt %) indicated below were calculated based on the total weight of the compositions.

TABLE 1A

| | SAMPLE 1 |
|---|---|
| Silica Filler (wt %) | 82.45 |
| Epoxy Cresol Novolac Resin (wt %) | 5.68 |
| Phenol Novolac Hardener (wt %) | 0.36 |
| Flexible Type Hardener | 3.25 |
| (Bisphenol-M) (wt %) | |
| Flexible Type Hardener | 1.48 |
| (xylock novolac type) (wt %) | |
| TPP Catalyst (wt %) | 0.02 |
| DBU Catalyst (wt %) | 0.13 |
| Melamine Cyanurate Flame Retardant | 1.70 |
| (Melapur MC-25 from DSM corp.) | |
| (wt %) | |
| Polyphenyleneoxide Stress Reliever | 1.00 |
| (wt %) | |
| Carbon Black Colorant (wt %) | 0.30 |
| Azine Adhesion Promoter (curezol 2MZ- | 0.02 |
| Azine from Shikoku Fine Chemical | |
| Corp.) (wt %) | |
| Ion Scavenger (wt %) | 1.58 |
| Waxes (wt %) | 0.98 |
| Silane Coupling agents (wt %) | 1.05 |

The molding composition of Sample 1 was cured and tested for flammability, gel time, and shelf life stability, with the results shown in Table 1B. The flammability properties of the cured compositions were determined by the total burn time of a ⅛″ molded bar according to the UL 94 test. According to the UL 94 test method, the molding composition was dispensed into molds and cured into ⅛ inch test pieces. Five test pieces are arranged such that the middle of a flame may contact the end portion of the test piece. The flame is maintained in such position relative to the test piece for a period of 10±0.5 seconds. The amount of time the test piece continues to flame after removal of the flame is termed the afterflame time. Once the test piece stops afterflaming, the flame is positioned toward the same portion of the test piece for an additional period of time of 10±0.5 seconds. After this time period, the flame is removed and this second afterflame time is measured. The afterglow time is also measured thereafter. After each flame application, five results are measured for the test pieces: (1) the first afterflame time; (2) the second afterflame time; (3) the afterglow time after the second afterflamming; (4) whether the test pieces burn to the clamps; and (5) whether the test pieces drip flaming particles. From these results, criteria conditions may be measured to determine whether the sample meets a V-0 designation. The general criteria conditions are set forth below:

| Criteria Conditions | V-0 | V-1 | V-2 |
|---|---|---|---|
| Afterflame time (first or second) | 10 secs | 30 secs | 30 secs |
| Total afterflame time for any condition | 50 secs | 250 secs | 250 secs |
| set | | | |
| Afterflame plus afterglow time for | 30 secs | 60 secs | 60 secs |
| each individual specimen after the | | | |
| second flame application | | | |
| Afterflame or afterglow of any | No | No | No |
| specimen up to the holding clamp | | | |
| Cotton indicator ignited by flaming | No | No | Yes |
| particles or drops | | | |

Gel time was determined through a standard testing procedure in which the compound is placed on a thermostatically-controlled hot plate which is controlled at a specified temperature. The compound is stroked with a spatula in a back-and-forth motion until it becomes stiff, with the time to stiffness representing the gel time. Shelf life stability was determined by testing the spiral flow at intervals according to a standard testing practice involving the use of a standard spiral flow mold in a transfer molding press. In the process, a sample of the composition is added to a transfer mold in a standard spiral flow mold, and the mold cycle is activated. When the mold cycle is complete, the mold is opened and the point of farthest continuous flow is recorded.

TABLE 1B

| TEST PROCEDURE | SAMPLE 1 |
|---|---|
| Flammability Test (UL 94) | |
| Total Burn Time (sec) | 47 |
| UL 94 Status | V-1 |
| Gel Time (sec) | 26 |
| Shelf Life Stability | |
| Spiral Flow at Room Temp (inches) | |
| Initial | 34 |
| 1 day | 28 |
| 2 days | 23 (68%) |
| Spiral Flow at 5° C. (inches) | |
| Initial | 36 |
| 1 week | 33 |
| 2 weeks | 31 (86%) |

### Example 2

Six molding compositions represented as Samples 2-6 were prepared according to the formulations as indicated in Table 2A below. Each molding composition contained a standard epoxy cresol novolac resin and a flexible novolac hardener, along with melamine cyanurate and tungsten trioxide as flame retardants at varying amounts. The weight % (wt %) indicated below were calculated based on the total weight of the compositions.

TABLE 2A

| | SAMPLE 2 | SAMPLE 3 | SAMPLE 4 | SAMPLE 5 | SAMPLE 6 |
|---|---|---|---|---|---|
| Silica Filler (wt %) | 80.98 | 80.98 | 80.98 | 81.17^{a} | 81.17^{b} |
| Epoxy Cresol Novolac Resin (wt %) | 6.16 | 6.27 | 6.49 | 5.92 | 5.92 |
| Phenol Novolac Hardener (wt %) | 0.18 | 0.18 | 0.18 | 0.18 | 0.18 |
| Flexible Type Hardener | 5.47 | 5.56 | 5.74 | 5.01 | 5.01 |
| (xylock novolac type) (wt %) | | | | | |
| TPP Catalyst (wt %) | 0.02 | 0.02 | 0.02 | 0.03 | 0.03 |
| DBU Catalyst (wt %) | 0.11 | 0.11 | 0.11 | 0.11 | 0.11 |
| Melamine Cyanurate Flame | 1.00 | 0.80 | 0.40 | 1.50 | 1.50 |
| Retardant (Melapur MC-25 from | | | | | |
| DSM Corp.) (wt %) | | | | | |
| WO₃ Flame Retardant (wt %) | 0.75 | 0.75 | 0.75 | 0.75 | 0.75 |
| Polyphenyleneoxide Stress Reliever | 1.50 | 1.50 | 1.50 | 1.50 | 1.50 |
| (wt %) | | | | | |
| Carbon Black Colorant (wt %) | 0.30 | 0.30 | 0.30 | 0.30 | 0.30 |
| Azine Adhesion Promoter (curezol | 0.02 | 0.02 | 0.02 | 0.02 | 0.02 |
| 2MZ-Azine from Shikoku Fine | | | | | |
| Chemical Corp.) (wt %) | | | | | |
| Ion Scavenger (wt %) | 1.58 | 1.58 | 1.58 | 1.58 | 1.58 |
| Waxes (wt %) | 0.88 | 0.88 | 0.88 | 0.88 | 0.88 |
| Silane Coupling agents (wt %) | 1.05 | 1.05 | 1.05 | 1.05 | 1.05 |

^{a}100% spherical silica
^{b}97% spherical silica, 3% crushed silica

Each of the molding compositions of Samples 2-6 were cured and tested for flammability, gel time, and shelf life stability in a similar manner as in Example 1, with the results shown in Table 2B.

TABLE 2B

| TEST PROCEDURE | SAMPLE 2 | SAMPLE 3 | SAMPLE 4 | SAMPLE 5 | SAMPLE 6 |
|---|---|---|---|---|---|
| Flammability Test (UL 94) | | | | | |
| Total Burn Time (sec) | 44 | 21 | 16 | 4 | 8 |
| UL 94 Status | V-1 | V-1 | V-0 | V-0 | V-0 |
| Gel Time (sec) | 24 | 23 | 24 | 22 | 23 |
| Flowability | | | | | |
| Spiral Flow at Room Temp | 35 | 36 | 41 | 40 | 40 |
| (inches) | | | | | |

The results of Table 2B demonstrate that molding compositions prepared with both melamine cyanurate and tungsten trioxide exhibit flame retardant properties, with most samples achieving a UL 94 V-0 rating.

The present invention has been described with reference to specific details of particular embodiments thereof. It is not intended that such details be regarded as limitations upon the scope of the invention except in so far as and to the extent that they are included in the accompanying claims.

What is claimed is:

1. A flame retardant molding composition substantially free of halogen, phosphorus, and antimony, comprising:
an epoxy resin;
melamine cyanurate; and
a transition metal oxide containing an oxyanion of a Group VIA element.

2. The molding composition of claim 1, wherein the transition metal oxide is tungsten oxide.

3. The molding composition of claim 1, wherein the tungsten oxide is tungsten trioxide.

4. The molding composition of claim 1, further comprising a phenolic novolac hardener.

5. The molding composition of claim 4, wherein the amount of the phenolic novolac hardener ranges from about 1.5 weight % to about 10 weight % based on the total weight of the molding composition.

6. The molding composition of claim 1, wherein the epoxy resin comprises an epoxy cresol novolac resin.

7. The molding composition of claim 6, wherein the epoxy resin comprises a biphenyl epoxy resin.

8. The molding composition of claim 1, wherein the melamine cyanurate is present in an amount of from about 0.1 to about 3.5 percent by weight of the molding composition and the transition metal oxide is present in an amount from about 0.1 to about 2 percent by weight of the molding composition.

9. The molding composition of claim 1, wherein the amount of the epoxy resin ranges from about 4 weight % to about 12 weight % based on the total weight of the molding composition.

10. The molding composition of claim 9, wherein the amount of the epoxy resin ranges from about 5.5% weight % to about 8.5 weight % based on the total weight of the molding composition.

11. The molding composition of claim 1, further comprising a bulk amount of a filler material.

12. A flame-retardant molding composition substantially free of elemental halogen, phosphorous, and antimony, comprising:
about 4 weight % to about 12 weight %, based on the total weight of the composition of an epoxy resin;
about 0.1 weight % to about 3.5 weight %, based on the total weight of the composition of melamine cyanurate;
about 0.1 weight % to about 2 weight %, based on the total weight of the composition of tungsten trioxide;
about 0.001 weight % to about 10 weight %, based on the total weight of the composition of a phenolic hardener; and
about 10 weight % to about 85 weight %, based on the total weight of the composition of a filler material.

13. The molding composition of claim 12, further comprising from about 0.1 weight % to about 10 weight %, based on the total weight of the composition, of one or more additives selected from the group consisting of colorants, mold release agents, coupling agents, catalysts, ion scavengers, metal oxides, metal hydroxides, pigments, adhesion promoters, toughening agents, UV absorbers, and antioxidants.

14. The molding composition of claim 12, wherein the epoxy resin comprises an epoxy cresol novolac resin.

15. The molding composition of claim 14, wherein the epoxy resin comprises a biphenyl epoxy resin.

16. A method of coating an electrical or electronic device, comprising providing a molding composition comprising an epoxy resin, a melamine cyanurate, and a transition metal oxide containing an oxyanion of a Group VIA element contacting a surface of the device with the molding composition and heating the molding composition to a temperature sufficient to cure the molding composition and form a polymer on a surface of the device.

17. The method of claim 16, wherein the cure temperature ranges from about 165° C. to about 195° C.

18. The method of claim 16, wherein the device is a semiconductor, a transistor, a diode, or an integrated circuit.

19. An electrical or electronic device formed by the method of claim 16.

20. The method of claim 16, wherein the transition metal oxide is tungsten trioxide.

21. The method of claim 16, wherein the molding composition further comprises a phenolic novolac hardener.

22. The method of claim 16, wherein the melamine cyanurate is present in an amount of from about 0.1 to about 3.5 percent by weight of the molding composition and the transition metal oxide is present in an amount from about 0.1 to about 2 percent by weight of the molding composition.

23. A method of imparting flame retardance to an epoxy molding composition comprising combining the epoxy molding composition with melamine cyanurate and a transition metal oxide containing an oxyanion of a Group VIA element.

24. The method of claim 23, wherein the transition metal oxide is tungsten trioxide.
